(19) United States
(12) Patent Application Publication
(10) Pub. No.: US 2017/0201767 A1
(43) Pub. Date: Jul. 13, 2017

(54) VIDEO ENCODING DEVICE AND VIDEO ENCODING METHOD

(71) Applicant: FUJITSU LIMITED, Kawasaki-shi (JP)

(72) Inventor: Satoshi SHIMADA, Kawasaki (JP)

(73) Assignee: FUJITSU LIMITED, Kawasaki-shi (JP)

(21) Appl. No.: 15/402,754

(22) Filed: Jan. 10, 2017

(30) Foreign Application Priority Data
Jan. 12, 2016 (JP) 2016-003664

(51) Int. Cl. H04N 19/50; H04N 19/105; H04N 19/196; H04N 19/61; H04N 19/18; H04N 19/176; H04N 19/124

(52) U.S. Cl. CPC H04N 19/50; H04N 19/176; H04N 19/105; H04N 19/124; H04N 19/61; H04N 19/18; H04N 19/198

(57) ABSTRACT

A video encoding device performs a process including calculating an area in which the locally-decoded image exists in an area for which the encoding process is terminated in a picture as the coding target and an area in which the locally-decoded image does not exist, generating a predicted image by using the locally-decoded image and an original image data when an area in which the locally-decoded image does not exist is included in a predicted-image block set in an area for which the encoding process is terminated in a picture as the coding target, and calculating an encoding cost on the basis of the predicted image and the original image data of the prediction unit block so as to calculate the predicted image resulting in the minimum encoding cost while changing a position of coordinates specified in an area for which the encoding process is terminated.

### CROSS-REFERENCE TO RELATED APPLICATION

This application is based upon and claims the benefit of priority of the prior Japanese Patent Application No. 2016-003664, filed on Jan. 12, 2016, the entire contents of which are incorporated herein by reference.

### FIELD

The embodiments discussed herein are related to a video encoding device.

### BACKGROUND

In video encoding, a compression process is implemented by combining a motion search process, an orthogonal transform process, etc. Accordingly, an immense amount of computations are conducted in an encoding device that encodes videos. While High Efficiency Video Coding (HEVC, whose standard name is ISO/IEC 23008-2|ITU-T H.265), standardized by ISO/IEC and ITU-T, achieves a compression performance that is nearly twice the performance achieved by H.264/MPEG-4 AVC, it needs a greater computation amount of encoding processes than H.264/MPEG-4 AVC does (see Non-patent Documents 1 and 2 for example).

As a technique for improving the throughput for encoding videos, pipelining is known. Pipelining determination of encoding parameters and processes such as an orthogonal transform process, a generation process of locally-decoded images, etc., can improve the throughput.

Also, in HEVC, introduction of a technique of highly efficient compression not only for videos that have been encoding targets for conventional video encoding (such as natural images captured by cameras) but also for images that are generated artificially by computers such as desktop screens of personal computers (PCs), computer graphics, etc. is being discussed. Screen content has a characteristic that the same patterns often appear in an image, which natural images do not have. In order to compress such repeated patterns efficiently, introduction of a technique by which coordinates of an area that has been encoded in a window are specified so that a predicted image is generated from a decoded image corresponding to the coordinates is being discussed in HEVC. This technique is referred to as Intra Block Copy (see Patent Document 1 for example). When Intra Block Copy is introduced, a process of generating a predicted image determines the most appropriate mode (encoding parameter) from among the three types of prediction modes, i.e., so-called normal intra prediction, inter prediction and Intra Block Copy.
Patent Document 1: US Patent Application Publication No. 2015/0063440 A1
Non-patent Document 1: “ISO/IEC 14496-10 (MPEG-4 Part 10)/ITU-T Rec.H.264”
Non-patent Document 2: “ISO/IEC 23008-2 (MPEG-H Part 2)/ITU-T Rec.H.265”

### SUMMARY

According to an aspect of the embodiment, a video encoding device includes: a memory; and a processor that is connected to the memory, that divides a picture as a coding target into a plurality of blocks so as to set a prediction unit block or a plurality of prediction unit blocks for each of the blocks, that generates a predicted image for the prediction unit block by using a locally-decoded image in an area for which an encoding process is terminated in a picture of the coding target for each of the prediction unit blocks, and that further performs a process of calculating the predicted image resulting in a minimum encoding cost, wherein the process of calculating the predicted image includes calculating an area in which the locally-decoded image exists in an area for which the encoding process is terminated in a picture as the coding target and an area in which the locally-decoded image does not exist, generating the predicted image by using the locally-decoded image in the predicted-image block and an original image data of an area in which the locally-decoded image does not exist when an area in which the locally-decoded image does not exist is included in a predicted-image block set in an area for which the encoding process is terminated in a picture as the coding target, and calculating an encoding cost on the basis of the predicted image and the original image data of the prediction unit block so as to calculate the predicted image resulting in the minimum encoding cost while changing a position of coordinates specified in an area for which the encoding process is terminated.

The object and advantages of the embodiment will be realized and attained by means of the elements and combinations particularly pointed out in the claims.

It is to be understood that both the foregoing general description and the following detailed description are exemplary and explanatory and are not restrictive of the embodiment.

### BRIEF DESCRIPTION OF DRAWINGS

FIG. 1 illustrates process-unit blocks for an encoding process;

FIG. 2 illustrates segmental shapes of prediction units;

FIG. 3 illustrates a prediction method based on Intra Block Copy;

FIG. 4 illustrates relationships between a coding tree unit receiving a prediction process and an area in which a locally-decoded image exists;

FIG. 5 illustrates an example of positional relationships between a predicted-image block and a locally-decoded image in Intra Block Copy;

FIG. 6 illustrates a functional configuration of a video encoding device according to an embodiment;

FIG. 7 illustrates a configuration of an IBC process unit;

FIG. 8 is a flowchart explaining a process performed by the IBC process unit;

FIG. 9 is a flowchart explaining a generation process of a predicted image that uses a locally-decoded image and an original image;

FIG. 10 explains a specifying method of an area in which a locally-decoded image does not exist in a predicted-image block;

FIG. 11 explains an example of a filter process;

FIG. 12 explains another example of a correction method of an encoding cost; and

FIG. 13 illustrates a hardware configuration of a computer.

### DESCRIPTION OF EMBODIMENTS

Preferred embodiments of the present invention will be explained with reference to accompanying drawings.

In Intra Block Copy, a prediction area corresponding to a block that is currently receiving a prediction process (prediction unit) is set for an encoded area in the picture that is being encoded currently, and a predicted image is generated by using a locally-decoded image of the prediction area. Then, the encoding cost is calculated by using the predicted image generated by the locally-decoded image and the original image of the block that is receiving a prediction process currently so as to determine an encoding parameter on the basis of the predicted image that results in the minimum encoding cost in a prescribed search scope.

However, pipelining an encoding process may cause a delay in the pipeline process between the process of determining an encoding parameter and the process of generating a locally-decoded image, leading to a situation where a locally-decoded image is not generated in a prediction area when the encoding parameter is determined. This sometimes prevents reference to an appropriate prediction area, reducing the encoding efficiency (compression efficiency) in Intra Block Copy.

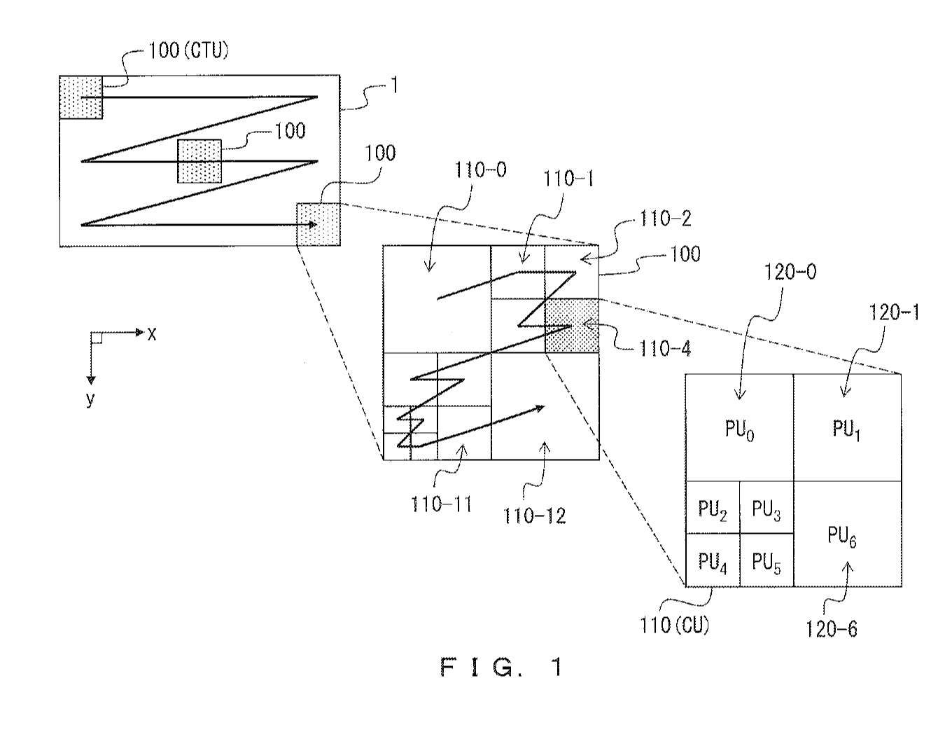

FIG. 1 illustrates process-unit blocks for an encoding process.

Encoding of video data is performed for each encoding-unit block by dividing the data (picture) for one window in video data into n×m encoding-unit blocks. In the H.265/HEVC standard (referred to as “HEVC” or a “HEVC standard” hereinafter), this encoding-unit block is referred to as a coding tree unit (CTU). In a HEVC standard, for example, one picture 1 is segmented into a plurality of coding tree units 100 and an encoding process and a decoding process for each coding tree unit 100 are performed in an order defined by a raster order as illustrated in FIG. 1.

The encoding and decoding processes for one coding tree unit (CTU) 100 is performed for each rectangular unit that is referred to as a coding unit (CU) set in the coding tree unit 100. The coding tree unit 100 can be segmented into a plurality of coding units 110 (110-0, 110-1, . . . , 110-12) through recursive quadtree block division as illustrated in for example FIG. 1. In the explanations below, when three is no need for distinguishing between a plurality of coding units, they will be referred to simply as “coding units 110”.

In recursive quadtree block division, one block of for example 64×64 pixels can be segmented into four blocks, each being of 32×32 pixels. Also, a block of 32×32 pixels can be segmented into four blocks, each being of 16×16 pixels. Further, a block of 16×16 pixels can be segmented into four blocks, each being of 8×8 blocks.

When one coding tree unit 100 is segmented into a plurality of coding units 110, the encoding processes are performed on the coding units 110 in the Z scan order as illustrated in for example FIG. 1. For this, a prediction mode can be switched between the in-screen prediction (intra prediction) mode and the inter-screen prediction (inter prediction) mode for each of the coding units 110.

Further, a prediction process in an encoding process for one coding unit (CU) 110 can be performed by treating one coding unit 110 as one prediction unit (PU) or by segmenting one coding unit 110 into a plurality of prediction units. When one coding unit 110 is segmented into a plurality of prediction units, the coding unit 110 can be segmented on the basis of a segmental shape pattern that is prepared in advance. For example, one coding unit 110 can be segmented into seven prediction units 120-0, 120-1, . . . , 120-6 as illustrated in FIG. 1. In the explanations below, when there is no need for distinguishing between a plurality of prediction units, they will be referred simply as “prediction units 120”.

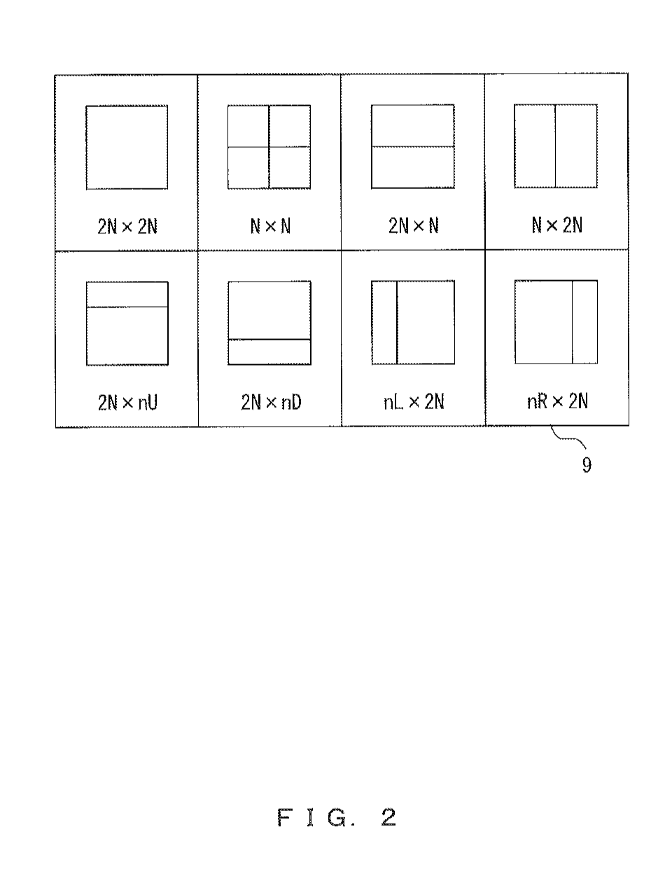

FIG. 2 illustrates segmental shapes of prediction units. A table 9 illustrated in FIG. 2 illustrates eight segmental shapes that can be set for segmenting the coding unit 110 into the plurality of prediction units 120. However, in the intra prediction mode, 2N×2N and N×N can only be selected as segmental shapes of the prediction units 120 from among the eight segmental shapes illustrated in the table 9 in FIG. 2. When 2N×2N is selected, the prediction unit 120 has the same size as that of the coding unit 110. Also, when N×N is selected, four prediction unit 120 can be set by segmenting the coding unit 110 into four square pixel blocks. In the inter prediction mode, 2N×N and N×2N can also be selected in addition to 2N×2N and N×N as segmental shapes of the prediction units 120. Further, when asymmetric motion segmentation is in effect in the inter prediction mode, 2N×nU, 2N×nD, nL×2N and nR×2N can be selected as segmental shapes of the prediction units 120.

It is possible to determine for each coding unit 110 which of the segmental shapes is to be used for the prediction process for that coding unit 110. Also, a parameter (such as a motion vector etc.) related to a prediction method in a prediction process can independently be specified for each prediction unit 120. When one coding unit 110 is segmented into the plurality of prediction units 120, the prediction processes for the prediction units 120 are performed in the Z scan order.

Also, generation, an orthogonal transform and a quantization process of a prediction error that are performed after a prediction process can be performed by treating one coding unit 110 as one transform unit (TU) or by segmenting one coding unit 110 into a plurality of transform units.

In an encoding process of a video, a predicted image is generated for a prediction unit 120 in the coding unit 110 by performing intra prediction or inter prediction in units of the coding units 110 as described above. In intra prediction, directionality prediction is performed from a neighboring pixel of the prediction unit 120 so as to generate a predicted image. In inter prediction, a motion compensation technique is used in which a picture encoded in the past is treated as a reference image, an area on the reference image is specified by a motion vector and a predicted image is generated from pixels in the area. Encoding using a predicted image generated on the basis of a result of inter prediction makes it possible to compress video data efficiently by performing this motion compensation to use the correlation in the time direction of the video.

Conventionally, coding standards including a HEVC standard have mainly targeted natural images (natural videos) captured by cameras etc. However, cases have increased in recent years that images generated artificially by computers such as desktop screens of computers, computer graphics, etc. (screen content). Accordingly, in a HEVC standard, introduction of a technique of highly efficient compression for various types of video data including screen content is being discussed. For example, in Virtual Desktop Infrastructure (VDI), image data (video data) periodically generated in a virtual machine in a server is transmitted to a client so that it is displayed by a display device of the client. In this VDI, in order to suppress a transfer delay caused in transmission (transfer) of video data generated in a server to a client, it is desired that the video data generated in the server be encoded efficiently.

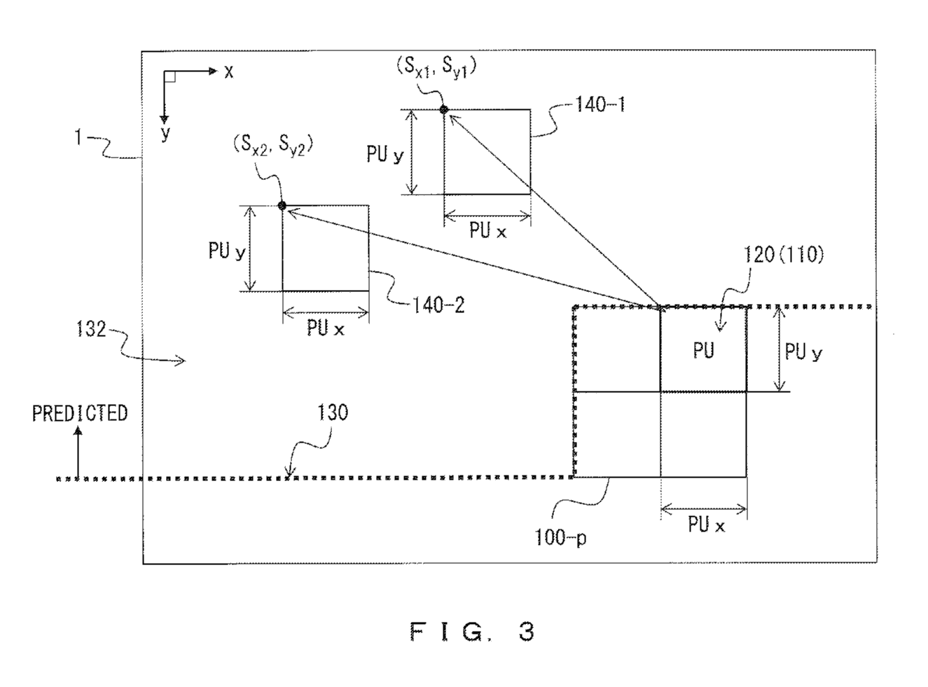

Screen content has a characteristic that the same patterns often appear in an image, which natural images do not have. In a HEVC standard, introduction of a new prediction technique called Intra Block Copy is being discussed as a technique for compressing video data containing such repeated patterns efficiently. Intra Block Copy is a prediction method in which coordinates of an area that has been encoded in a picture for which the encoding process is currently being performed are specified so that a predicted image is generated from a locally-decoded image corresponding to the coordinates. A prediction method based on the above Intra Block Copy will be explained by referring to FIG. 3.

FIG. 3 illustrates a prediction method based on Intra Block Copy. FIG. 3 illustrates examples of a prediction unit and a predicted-image block for a case when Intra Block Copy is performed on the coding tree unit 100-p for which the prediction process is currently being performed in the picture 1. The coding tree unit 100-p has been segmented into four coding units 110, and Intra Block Copy is being performed on the upper right coding unit 110 FIG. 3. In other words, FIG. 3 illustrates an example in which the upper right coding unit 110 is treated as one prediction unit 120 from among the four coding units so that Intra Block Copy is being performed.

Differently from normal intra prediction, which performs directionality prediction from a neighboring pixel of the prediction unit 120, Intra Block Copy can search an arbitrary area in an encoded area in order to detect a predicted image for the prediction unit 120. When the encoding and decoding processes have been pipelined, the encoding and decoding processes are sequentially performed on a coding tree unit that has received a prediction process before coding tree unit 100-p that is currently receiving the prediction process. When the encoding process is being performed in the raster scan order from the coding tree unit located at the upper left corner of the picture 1, an area 132 higher than a boundary 130, which is hooked and is drawn in a thick line in FIG. 3, becomes an area that has already received the prediction process. Hereinafter, the area 132 higher than the boundary 130 will be referred to as a predicted area 132.

In other words, Intra Block Copy generates a predicted image by setting many predicted-image blocks including predicted-image blocks 140-1 and 140-2 in the predicted area 132 in the picture 1 as illustrated in FIG. 3. The predicted-image block 140-1 is a rectangular area that is specified by a search point (Sₓ₁, S_{y1}) and a prediction unit size PUx×PUy. Also, the predicted-image block 140-2 is a rectangular area specified by a search point (Sₓ₂,S_{y2}) and a prediction unit size PUx×PUy. Intra Block Copy reads a rectangular area specified by the above position and size of a predicted-image block from a locally-decoded image of the picture 1 so as to treat it as a predicted image. Then, a predicted image resulting in a minimum encoding cost, which is calculated on the basis of a predicted image and a prediction unit, is calculated.

Introduction of Intra Block Copy to a HEVC standard, makes it possible to select the most appropriate mode from among Intra Block Copy prediction mode, the intra prediction mode and the inter prediction mode in units of the coding units 110.

Incidentally, a locally-decoded image used for generating a predicted image is generated by performing a decoding process on a signal encoded in the video encoding device. Also, as a technique for improving the throughput of encoding processes and decoding processes, pipelining is known. Pipelining determination of encoding parameters and processes such as an orthogonal transform process, a generation process of locally-decoded images, etc., can improve the throughput. However, pipelining may cause a pipeline delay between determination of an encoding parameter and generation of a locally-decoded image, leading to a situation where a locally-decoded image of a neighboring block has not been generated before a timing for determining the encoding parameter.

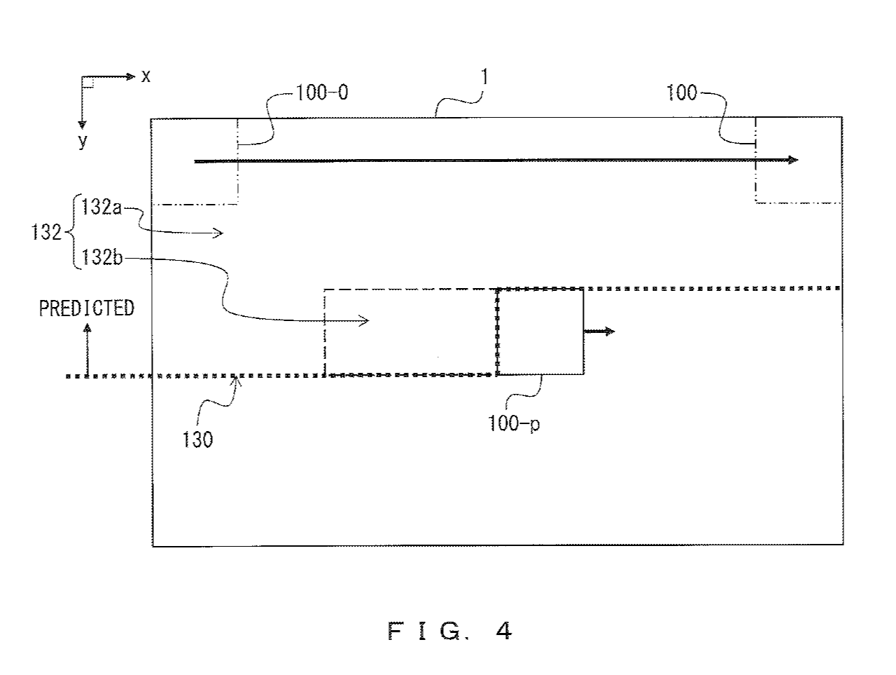

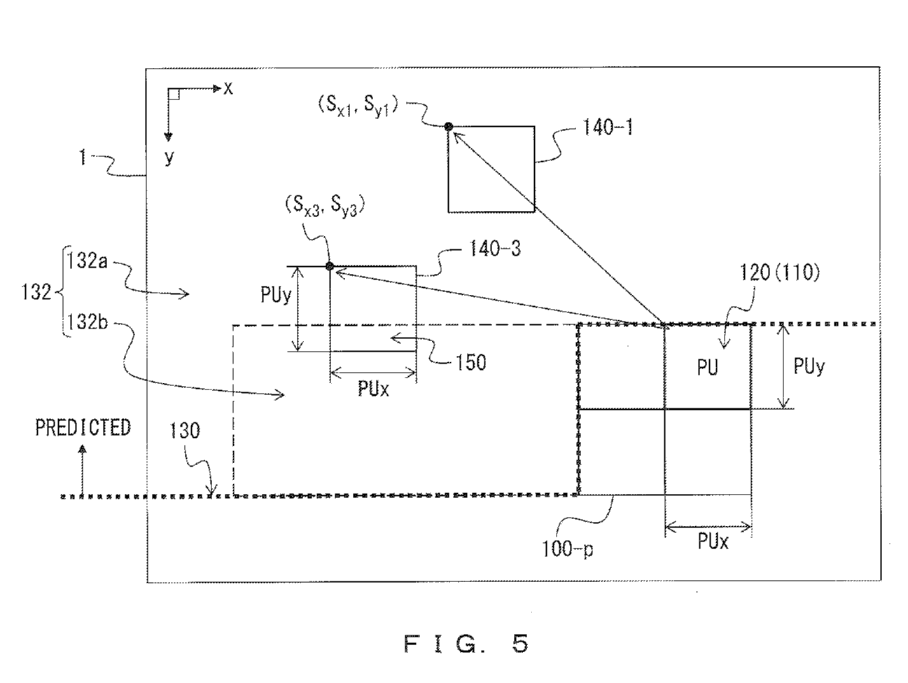

FIG. 4 illustrates relationships between a coding tree unit receiving a prediction process and an area in which a locally-decoded image exists. FIG. 5 illustrates an example of positional relationships between a predicted-image block and a locally-decoded image in Intra Block Copy.

In FIG. 4, the encoding of the picture 1 is being performed in the raster scan order from the coding tree unit 100-0 at the upper left corner with the short side directions of the picture 1 being the vertical directions of the window. Accordingly, at the moment when the prediction process is being performed on the coding tree unit 100-p in the picture 1, the area higher than the boundary 130, which is hooked and is drawn in a thick line in FIG. 4 in the picture 1, becomes the predicted area 132. For the coding tree units 100 included in this predicted area 132, encoding processes such as the orthogonal transform, the quantization, etc. and a decoding process are sequentially performed by a pipelining process after the prediction process is terminated.

However, occurrence of a pipeline delay may result in a situation where a locally-decoded image has not been generated in a coding tree unit located that is previous, by one through several units, to the coding tree unit 100-p currently receiving the prediction process in the raster scan order. In other words, occurrence of a pipeline delay makes the predicted area 132 include an area 132a in which a locally-decoded image exists and an area 132b in which a locally-decoded image does not exist. Accordingly, occurrence of a pipeline delay may cause a prediction process (a process of determining an encoding parameter) for the coding tree unit 100-p to start with the predicted area 132 involving the area 132b in which a locally-decoded image does not exist.

In a case when Intra Block Copy is performed in this situation, when an entire block is included in the area 132a in which a locally-decoded image exists like the predicted-image block 140-1 illustrated in FIG. 5 for example, a predicted image using a locally-decoded image can be generated. The predicted-image block 140-1 is one predicted-image block in Intra Block Copy for the prediction unit 120 of the coding tree unit 100-p. This predicted-image block 140-1 is a rectangular area specified by a search point (Sₓ₁,S_{y1}) and the prediction unit size PUx×PUy as illustrated in FIG. 3.

When a partial area 150 in a block is included in the area 132b in which a locally-decoded image does not exist like another predicted-image block 140-3 illustrated in FIG. 5, a locally-decoded image does not exist for the area 150. This prevents generation of a predicted image for the entire predicted-image block 140-3 by using a locally-decoded image. The predicted-image block 140-3 is one predicted-image block in Intra Block Copy for the prediction unit 120 of the coding tree unit 100-p. This predicted-image block 140-3 is a rectangular area specified by a search point (Sₓ₃,S_{y3}) and the prediction unit size PUx×PUy as illustrated in FIG. 5.

In other words, because the area 132b in which a locally-decoded image does not exist is included inside, it is not possible for the predicted-image block 140-3 as it is to become a predicted image for the prediction unit 120 currently receiving the prediction process. Accordingly, when the predicted area 132 includes the area 132b not having a locally-decoded image in it, the scope over which a search can be made for a predicted image for the prediction unit 120 that is currently receiving the prediction process may be limited, preventing generation of the most appropriate predicted image.

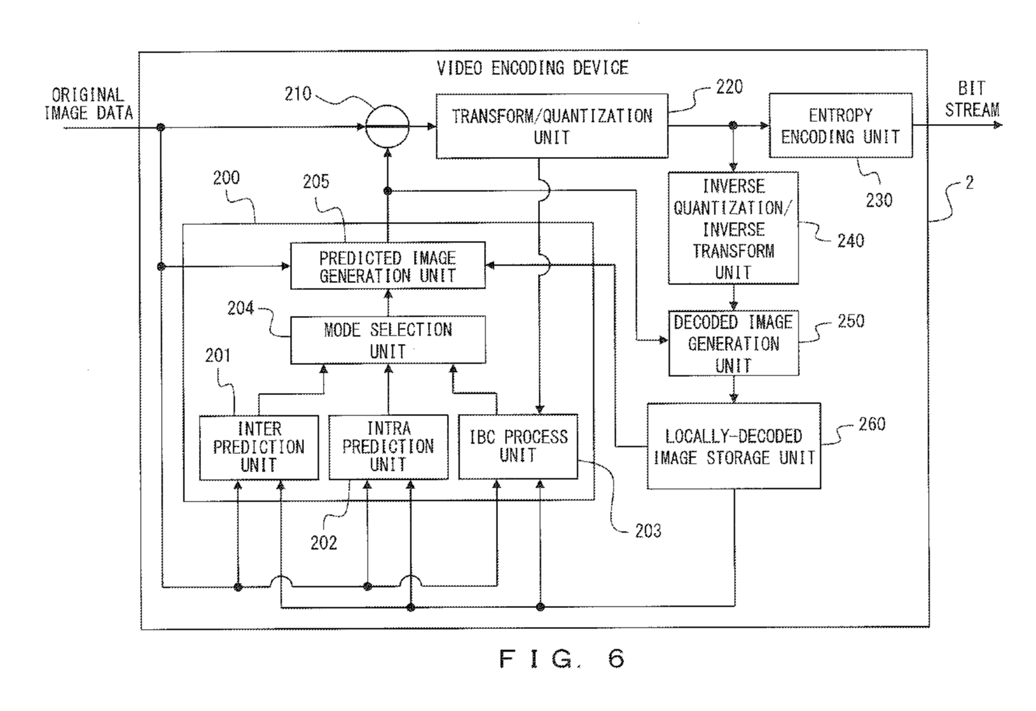

FIG. 6 illustrates a functional configuration of a video encoding device according to an embodiment.

As illustrated in FIG. 6, a video encoding device 2 of the present embodiment includes a prediction process unit 200, a prediction error signal generation unit 210, a transform/quantization unit 220, and an entropy encoding unit 230. Also, the video encoding device 2 includes an inverse quantization/inverse transform unit 240, a decoded image generation unit 250 and a locally-decoded image storage unit 260. The prediction process unit 200, the prediction error signal generation unit 210, the transform/quantization unit 220 and the entropy encoding unit 230 in the video encoding device 2 perform an encoding process. Also, the inverse quantization/inverse transform unit 240 and the decoded image generation unit 250 in the video encoding device 2 perform a decoding process.

The prediction process unit 200 performs a prediction process by using a picture (original image data) of a coding target and a locally-decoded image stored in the locally-decoded image storage unit, and thereby generates a predicted image. In coding based on a HEVC standard, the prediction process unit 200 generates a predicted image for each prediction unit 120 included in one coding unit 110, and outputs them collectively as a predicted image of one coding unit 110. The prediction process unit 200 includes an inter prediction unit 201, an intra prediction unit 202, an IBC process unit 203, a mode selection unit 204 and a predicted image generation unit 205. The inter prediction unit 201 performs inter prediction including a motion search and motion compensation that refer to other pictures that have been encoded. The intra prediction unit 202 performs intra prediction that refers to a pixel neighboring a block (prediction unit) that is receiving a prediction process in a picture of a coding target. The IBC process unit 203 performs a prediction process based on Intra Block Copy. On the basis of a prediction result of the inter prediction unit 201, the prediction result of the inter prediction unit 201 and a prediction result of the IBC process unit 203, the mode selection unit 204 selects an encoding mode (encoding parameter) for a prediction unit that is receiving a prediction process. The predicted image generation unit 205 generates a predicted image for a prediction unit receiving a prediction process, on the basis of the selected encoding mode. After generating a predicted image for one coding unit 110, the prediction process unit 200 outputs the generated predicted image to the prediction error signal generation unit 210 and the decoded image generation unit 250.

The prediction error signal generation unit 210 generates a prediction error signal that represents a difference between an original image data for a block (coding unit) for which a prediction process is terminated and a predicted image generated by the prediction process unit 200. The prediction process unit 200 outputs a generated prediction error to the transform/quantization unit 220.

The transform/quantization unit 220 performs orthogonal transform on a prediction error and quantizes a transform coefficient obtained by the orthogonal transform. The transform/quantization unit 220 outputs a quantized transform coefficient (referred to simply as a “coefficient” hereinafter) to the entropy encoding unit 230 and the inverse quantization/inverse transform unit 240. The transform/quantization unit 220 outputs, to the IBC process unit 203, a quantization parameter used for quantizing each transform block (TU) of the coding unit 110.

The entropy encoding unit 230 performs entropy coding (variable-length coding) on a quantized coefficient so as to output it as a bit stream.

The inverse quantization/inverse transform unit 240 performs inverse quantization on a quantized coefficient, and performs inverse orthogonal transform on a transform coefficient restored by the inverse quantization. In other words, the inverse quantization/inverse transform unit 240 performs a process of recovering a prediction error signal before orthogonal transform is performed by the transform/quantization unit 220 on the basis of a quantized coefficient. The inverse quantization/inverse transform unit 240 outputs a recovered signal to the decoded image generation unit 250.

On the basis of a signal recovered by the inverse quantization/inverse transform unit 240 and a predicted image generated by the prediction process unit 200 (predicted image generation unit 205), the decoded image generation unit 250 generates a locally-decoded image. Also, the decoded image generation unit 250 performs a filter process for reducing noise etc. appearing in a generated locally-decoded image, e.g., a deblocking filter process or a Sample Adaptive Offset (SAO) process. The decoded image generation unit 250 stores a locally-decoded image after a filter process in the locally-decoded image storage unit 260. The locally-decoded image stored in the locally-decoded image storage unit 260 is referred to by the prediction process unit 200 for performing a prediction process.

The inter prediction unit 201 and the intra prediction unit 202 of the prediction process unit 200 in the video encoding device 2 of the present embodiment respectively performs inter prediction and intra prediction based on a known HEVC standard by using original image data and a locally-decoded image. The inter prediction unit 201 outputs, to the mode selection unit 204, a prediction result (encoding parameter) including a motion vector obtained by inter prediction and an encoding cost. The intra prediction unit 202 outputs, to the mode selection unit 204, a prediction result (encoding parameter) including a prediction mode obtained by intra prediction and an encoding cost.

Also, the IBC process unit 203 of the prediction process unit 200 uses original image data, a locally-decoded image and a quantization parameter so as to perform generation of generation of a predicted image based on the above Intra Block Copy and an encoding cost, calculation of encoding cost, etc. The IBC process unit 203 outputs, to the mode selection unit 204, a prediction result (encoding parameter) including a predicted-image block obtained by Intra Block Copy and an encoding cost.

On the basis of prediction results from the inter prediction unit 201, the intra prediction unit 202 and the IBC process unit 203, the mode selection unit 204 selects an encoding mode that results in a minimum encoding cost. The mode selection unit 204 outputs, to the predicted image generation unit 205, an encoding parameter corresponding to the selected encoding mode.

In accordance with the encoding parameter selected by the mode selection unit 204, the predicted image generation unit 205 generates a predicted image by using original image data and a locally-decoded image. The predicted image generation unit 205 outputs the generated predicted image to the prediction error signal generation unit 210 and the decoded image generation unit 250.

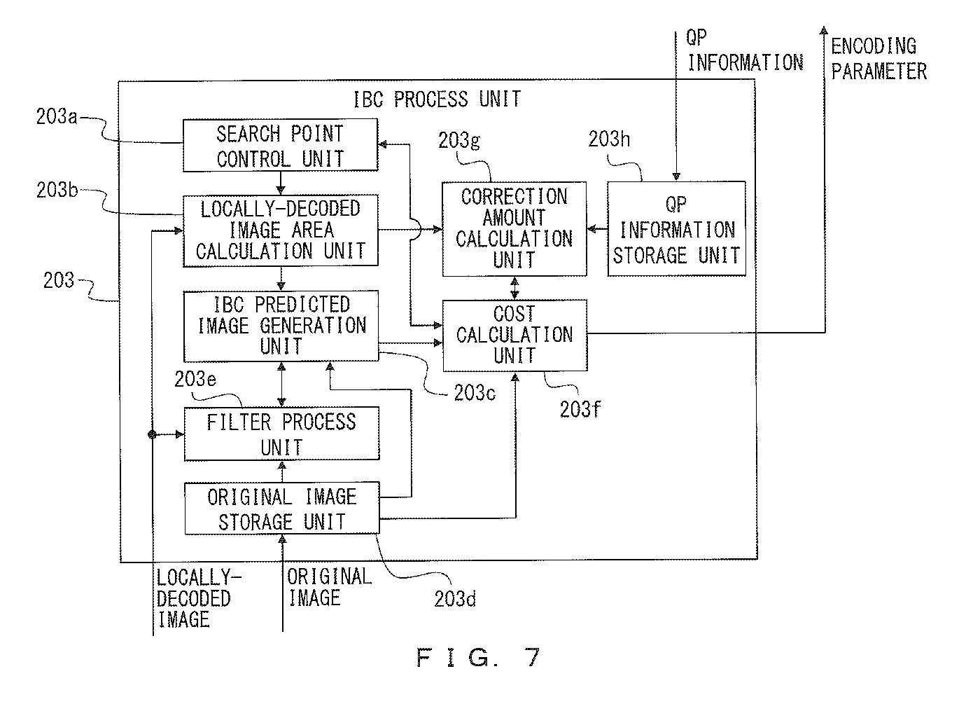

FIG. 7 illustrates a configuration of an IBC process unit.

As illustrated in FIG. 7, the IBC process unit 203 includes a search point control unit 203a, a locally-decoded image area calculation unit 203b, an IBC predicted image generation unit 203c, an original image storage unit 203d and a filter process unit 203e. Also, the IBC process unit 203 includes a cost calculation unit 203f, a correction amount calculation unit 203g and a QP information storage unit 203h.

The search point control unit 203a performs a control process of specifying, switching, etc. of a search point (or a position at which a predicted-image block is generated) in the picture 1 in an IBC process.

The locally-decoded image area calculation unit 203b refers to the locally-decoded image storage unit 260 so as to calculate an area in which a locally-decoded image exists in a predicted-image block corresponding to a specified search point and an area in which a locally-decoded image does not exit. The locally-decoded image area calculation unit 203b outputs, to the IBC predicted image generation unit 203c, for example area information representing the position and dimensions of an area in which a locally-decoded image does not exit.

On the basis of area information calculated by the locally-decoded image area calculation unit 203b, the IBC predicted image generation unit 203c generates a predicted image based on Intra Block Copy. When all areas in the predicted-image block include locally-decoded images, the IBC predicted image generation unit 203c generates a predicted image by using the locally-decoded images in the predicted-image block. When a predicted-image block includes an area in which a locally-decoded image does not exit, the IBC predicted image generation unit 203c generates a predicted image by using a locally-decoded image and an original image. Then, the IBC predicted image generation unit 203c uses a locally-decoded image for an area in which a locally-decoded image exits. For an area in which a locally-decoded image does not exit, the IBC predicted image generation unit 203c uses an original image that was stored in the original image storage unit 203d. Also, when a predicted image is generated by using a locally-decoded image and an original image, the IBC predicted image generation unit 203c makes the filter process unit 203e perform a filter process for the boundary between an area of the locally-decoded image and the original image in the predicted image.

The filter process unit 203e performs a filter process of reducing noise etc. appearing on for example the boundary between an area of a locally-decoded image and the original image in a predicted image. The filter process unit 203e performs a filter process by a three-tap filter for a combination of three locally-decoded images that continue in the horizontal or vertical directions at the boundary between an area of a locally-decoded image and the original image and a pixel of the original image.

The cost calculation unit 203f calculates an encoding cost on the basis of a predicted image generated by the IBC predicted image generation unit 203c and the original image of the prediction unit 120 that is currently receiving a prediction process. Also, when an original image is included in a predicted image, the cost calculation unit 203f makes the correction amount calculation unit 203g calculate a correction amount in order to correct an error of an encoding cost caused by the use of an original image for part of the predicted image. Also, when an original image is included in a predicted image, the cost calculation unit 203f corrects an encoding cost calculated from a predicted image and an original image on the basis of the correction amount calculated by the correction amount calculation unit 203g. Further, the cost calculation unit 203f holds the encoding parameter corresponding to the minimum encoding cost from among encoding costs sequentially calculated by changing a search point for one prediction unit 120. When the IBC process for one prediction unit 120 is terminated, the cost calculation unit 203f outputs, to the mode selection unit 204, the encoding parameter resulting in the minimum encoding cost. An encoding parameter for a predicted image output by the cost calculation unit 203f includes a search point representing the position of a predicted image and an encoding cost.

The correction amount calculation unit 203g calculates an estimated value of a quantization error caused when a pixel to which an original image is assigned in a predicted image for example is quantized. The correction amount calculation unit 203g obtains, from the locally-decoded image area calculation unit 203b, for example a pixel to which an original image is assigned. The correction amount calculation unit 203g reads quantization parameter qp used for calculation of the estimated value of a quantization error from the QP information storage unit 203h. The QP information storage unit 203h stores information related to quantization parameter qp obtained from the transform/quantization unit 220.

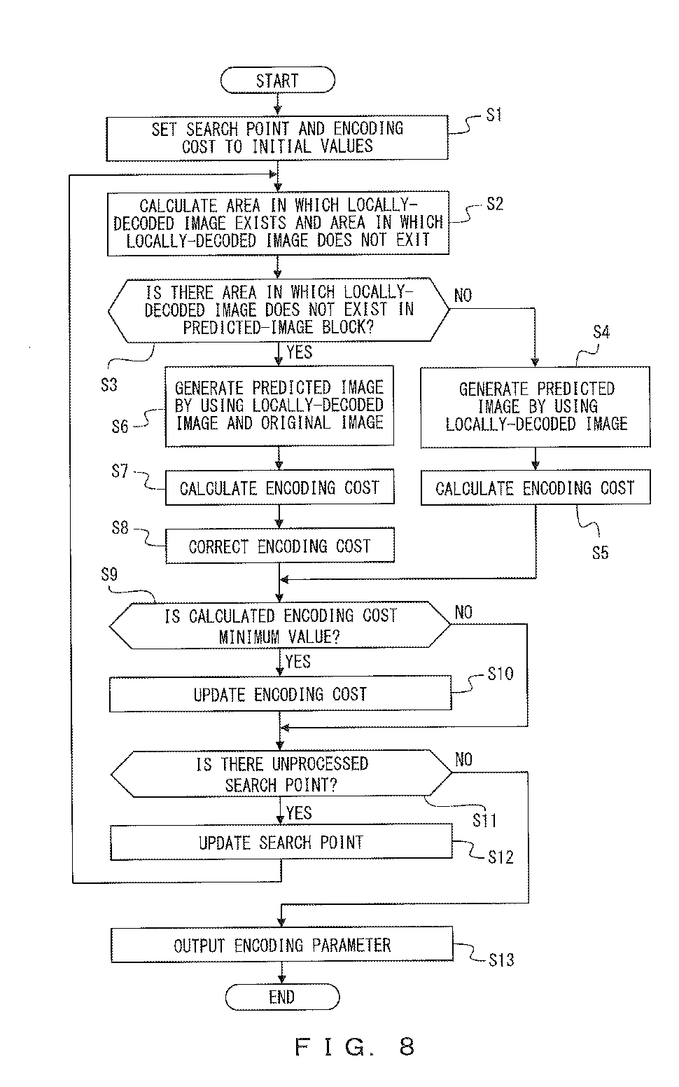

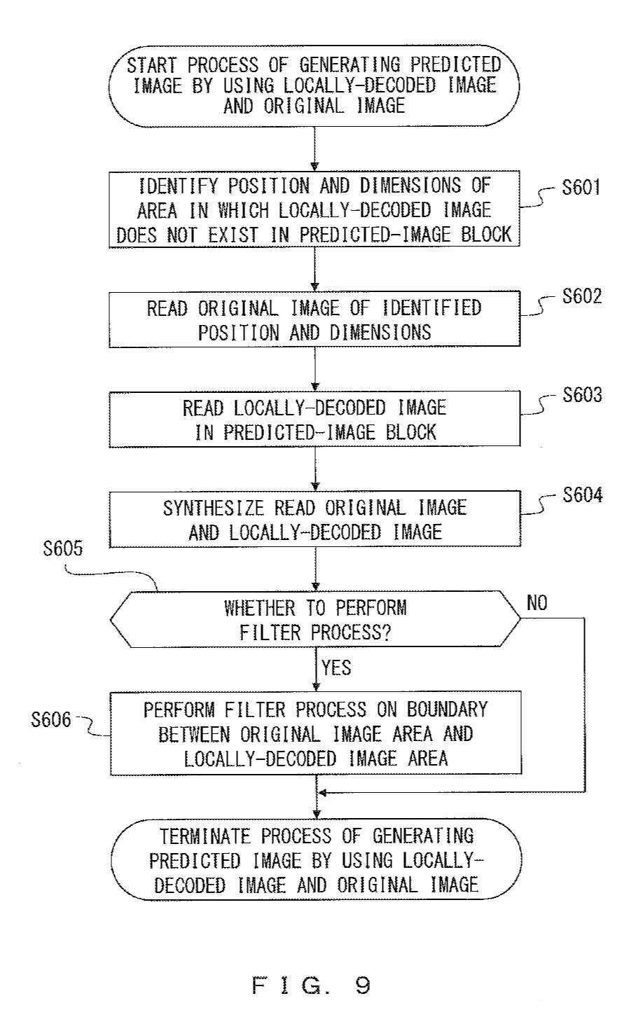

The video encoding device 2 of the present embodiment encodes video data in accordance with a HEVC standard as described above. However, in the prediction process unit 200, prediction by the IBC process unit 203 is performed in addition to prediction by the inter prediction unit 201 and the intra prediction unit 202. The inter prediction unit 201 and the intra prediction unit 202 respectively perform inter prediction (inter-image prediction) and intra prediction (in-image prediction) in accordance with known prediction procedures in a HEVC standard. The IBC process unit 203 performs for example the processes illustrated in FIG. 8 and FIG. 9.

FIG. 8 is a flowchart explaining a process performed by the IBC process unit. FIG. 9 is a flowchart explaining a generation process of a predicted image that uses a locally-decoded image and an original image. Note that the flowchart in FIG. 8 illustrates the content of a process performed by the IBC process unit 203 for one prediction unit (PU).

When a prediction unit as a process target is specified, the IBC process unit 203 first sets a search point and an encoding cost to the initial values (step S1) as illustrated in FIG. 8. Step S1 is performed by the search point control unit 203a. The search point control unit 203a sets the position of the first search point in accordance with for example the position of a prediction unit as a process target, a prescribed search scope (setting scope of a predicted-image block) and the setting order of search points, and reports it to the locally-decoded image area calculation unit 203b. Also, the search point control unit 203a reports the initial value of an encoding cost to the cost calculation unit 203f. On the basis of a minimum value of an encoding cost calculated by Intra Block Copy that uses for example a plurality of types of original images prepared in advance, the initial value of an encoding cost is set to a value greater than the minimum value. The cost calculation unit 203f sets the value of an encoding cost to a reported initial value, the encoding cost being used for determination, which will be described later.

Next, the IBC process unit 203 calculates an area in which a locally-decoded image exists in a picture and an area in which a locally-decoded image does not exit (step S2). Step S2 is performed by the locally-decoded image area calculation unit 203b. The locally-decoded image area calculation unit 203b refers to the locally-decoded image storage unit 260 so as to calculate area information representing the positions of an area 132a in which a locally-decoded image exists in the already-predicted area 132a in the predicted area 132 of the picture that is currently receiving a encoding process and the area 132b in which it does not exit. The locally-decoded image area calculation unit 203b reports the calculated area information to the IBC predicted image generation unit 203c.

Receiving area information from the locally-decoded image area calculation unit 203b, the IBC predicted image generation unit 203c determines whether or not a predicted-image block to be set includes an area in which a locally-decoded image does not exist, on the basis of a specified search point (step S3). When all areas in the predicted-image block are areas in which locally-decoded images exist (NO in step S3), the IBC predicted image generation unit 203c generates a predicted image by using the locally-decoded images in the predicted-image block (step S4). Then, the IBC predicted image generation unit 203c outputs, to the cost calculation unit 203f, the predicted image generated in step S4 and information representing that all areas in the predicted-image block are areas in which locally-decoded images exist (i.e., information representing that an original image is not included in a predicted image). The cost calculation unit 203f that has received the predicted image and the information calculates an encoding cost on the basis of the received predicted image and the original image in the original image storage unit 203d (step S5). When all areas in the predicted-image block are areas in which locally-decoded images exist and when an original image is not used for generating a predicted image, the cost calculation unit 203f treats an encoding cost calculated in step S5 as an encoding cost for the predicted-image block.

When there is an area in which a locally-decoded image does not exist (YES in step S3), the IBC predicted image generation unit 203c generates a predicted image by using a locally-decoded image and an original image (step S6). Then, the IBC predicted image generation unit 203c outputs, to the cost calculation unit 203f, information representing that the predicted image generated in step S6, the fact that an original image is included in a predicted image and the area of an original image. The cost calculation unit 203f that has received the predicted image and the information calculates an encoding cost on the basis of the received predicted image and the original image in the original image storage unit 203d (step S7). Also, detecting that an original image is included in a predicted image from the received information, the cost calculation unit 203f makes the correction amount calculation unit 203g calculate the correction amount of the encoding cost, and corrects the encoding cost on the basis of the correction amount (step S8). When an area in which a locally-decoded image does not exist is included in a predicted-image block, i.e., when an original image was used for generating a predicted image, the cost calculation unit 203f treats the encoding cost corrected in step S8 as an encoding cost for the predicted-image block.

After calculating an encoding cost, the cost calculation unit 203f determines whether or not the calculated encoding cost is a minimum value (step S9). The cost calculation unit 203f compares the minimum value of the current encoding cost and the encoding cost calculated in the immediately previous process in a process for one prediction unit, and determines whether or not the encoding cost calculated in the immediately previous process is a minimum value. In this example, the encoding cost calculated in the immediately previous process is the process in step S5 for the predicted-image block (search point) that is currently set or the encoding cost calculated in the process in step S8. In case of the first determination for one prediction unit, the cost calculation unit 203f compares the initial value set in step S1 and the encoding cost that was calculated immediately previously. When the encoding cost calculated immediately previously is not a minimum value (NO in step S9), the cost calculation unit 203f does not change the minimum value of the encoding cost, and reports, to the search point control unit 203a, that the process of the specified search point has been terminated. When the encoding cost calculated immediately previously is the minimum (YES in step S9), the cost calculation unit 203f updates the minimum value of the encoding cost, and thereafter reports, to the search point control unit 203a, that the process for the specified search point has been terminated.

Receiving a report that the process has been terminated from the cost calculation unit 203f, the search point control unit 203a determines whether or not there is a unprocessed search point (step S11). When there is an unprocessed search point (YES in step S11), the search point control unit 203a updates the search point (step S12), and reports the updated search point to the locally-decoded image area calculation unit 203b. Thereby, the process performed by the IBC process unit 203 returns to step S2. Thereafter, the IBC process unit 203 repeats the processes in step S2 through step S12 until there becomes no unprocessed search point. When the processes in step S2 through step S10 have been performed on all search points (NO in step S11), the IBC process unit 203 outputs, to the mode selection unit 204, the encoding parameter that results in a minimum encoding cost (step S13). When it is determined that the processes have been performed for all search points in step S11, the search point control unit 203a instructs the cost calculation unit 203f to output the encoding parameter. Receiving the instruction from the search point control unit 203a, the cost calculation unit 203f outputs, to the mode selection unit 204, the encoding parameter for the predicted image that results in a minimum encoding cost.

As described above, when there is an area in which a locally-decoded image does not exist in a predicted-image block, the IBC process unit 203 in the video encoding device 2 in the present embodiment generates a predicted image that uses an original image for the area. Accordingly, in a process performed by the IBC process unit 203 of the present embodiment, a predicted-image block including an area 132b in which a locally-decoded image does not exist can also be a target of prediction based on Intra Block Copy from among the predicted area 132.

Next, by referring to FIG. 9, explanations will be given for the process in step S6 in the flowchart of FIG. 8, i.e., a generation process of a predicted image for a case when there is an area in which a locally-decoded image does not exist in a predicted-image block. FIG. 9 is a flowchart explaining a generation process of a predicted image that uses a locally-decoded image and an original image.

When there is an area in which a locally-decoded image does not exist in a predicted-image block, the IBC predicted image generation unit 203c generates a predicted image by using a locally-decoded image and an original image. Then, the IBC predicted image generation unit 203c first identifies the position and dimensions of the area in which a locally-decoded image does not exist in the predicted-image block as illustrated in FIG. 9 (step S601). In step S601, the IBC predicted image generation unit 203c identifies the position and dimensions of the area in which a locally-decoded image does not exist on the basis of area information reported from the locally-decoded image area calculation unit 203b.

Next, the IBC predicted image generation unit 203c reads an original image of the position and dimension specified in step S601 in the picture (step S602). In step S602, the IBC predicted image generation unit 203c reads partial data corresponding to the position and dimensions identified in step S601 from among pieces of original image data of pictures, stored in the original image storage unit 203d, that is currently receiving an encoding process.

Next, the IBC predicted image generation unit 203c reads a locally-decoded image in a predicted-image block (step S603). In step S603, the IBC predicted image generation unit 203c reads a locally-decoded image in a predicted-image block from the locally-decoded image storage unit 260 on the basis of a search point specified by the search point control unit 203a and the dimensions of a predicted-image block. The locally-decoded image read then is an image that lacks some of the areas in the predicted-image block.

Next, the IBC predicted image generation unit 203c generates a predicted image by synthesizing the read original image and locally-decoded image (step S604). In step S604, the IBC predicted image generation unit 203c fits the read original image into the lacking area in the locally-decoded image so as to generate one rectangular predicted image that corresponds to the outline of the predicted-image block.

Note that a predicted image generated in step S604 is a result of arranging a locally-decoded image on which quantization error components are superimposed and an original image in which a quantization error components can be considered zero so as to form one predicted image. Accordingly, a predicted image generated in step S604 may cause discontinuity of pixels for the amount of quantization errors at the boundary between an area of a locally-decoded image and an area of an original image, resulting in noise in encoding cost.

Accordingly, the IBC predicted image generation unit 203c next determines whether or not to perform a filter process on a predicted image generated in the step S604 (step S605). In step S605, the IBC predicted image generation unit 203c determines to perform a filter process when a quantization error for a pixel along the boundary with an area of an original image in an area of a locally-decoded image is greater than a prescribed threshold, for example.

Determining to perform a filter process (YES in step S605), the IBC predicted image generation unit 203c next makes the filter process unit 203e perform a filter process on the boundary between an area of a locally-decoded image and an area of an original image data (step S606). In step S606, the IBC predicted image generation unit 203c reports, to the filter process unit 203e, information representing the position of the boundary between an area of a locally-decoded image and an area of original image data and information specifying a filter process to be applied, and makes the filter process unit 203e perform the filter process. The filter process unit 203e performs a filter process on the basis of information reported from the IBC predicted image generation unit 203c. The filter process unit 203e performs (applies) a prescribed three-tap filter on for example a combination of three pixels including a locally-decoded image pixel and an original image pixel arranged in the horizontal directions or the vertical directions. On the basis of information representing the position of the boundary, the filter process unit 203e reads the pixel values of three pixels neighboring in the boundary portion and performs the above three-tap filter. Terminating the filter process, the filter process unit 203e reports, to the IBC predicted image generation unit 203c, the process result, i.e., the pixel values after the filter process at the boundary between the area of the locally-decoded image and the area of the original image. Receiving the pixel values after the filter process from the filter process unit 203e, the IBC predicted image generation unit 203c rewrites pixel values in the boundary portion in the predicted image generated in step S604. Thereby, the process in step S606 is terminated, and a process of generating a predicted image that uses a locally-decoded image and an original image is terminated.

When it is determined not to perform a filter process (NO in step S605), the IBC predicted image generation unit 203c skips the process in step S606, and terminates a generation process of a predicted image that uses a locally-decoded image and an original image.

The flowchart illustrated in FIG. 9 determines whether or not to perform a filter process, this flowchart may always perform a filter process (step S606) when a predicted image has been generated by using a locally-decoded image and an original image. Also, when a filter process is performed, the filter process unit 203e may obtain a pixel used for a filter process from a predicted image generated by the IBC predicted image generation unit 203c.

As described above, when there is an area in which a locally-decoded image does not exist in a predicted-image block, the IBC process unit 203 in the video encoding device 2 of the present embodiment generates a predicted image using an original image for the area. This makes it possible to generate a predicted image even when a delay is caused in a process after for example a prediction process and there is an area in which a locally-decoded image is not generated in a search scope at a timing at which an IBC process is performed on a prediction unit. Accordingly, in a process performed by the IBC process unit 203 of the present embodiment, an area in which a locally-decoded image has not been generated from among the areas that terminated the prediction process can also be a target of prediction. Thus, according the present embodiment, restrictions of a search scope of a predicted image caused by non-existence of a locally-decoded image when prediction is performed by Intra Block Copy is suppressed (relaxed), increasing a possibility that the most appropriate predicted image will be generated.

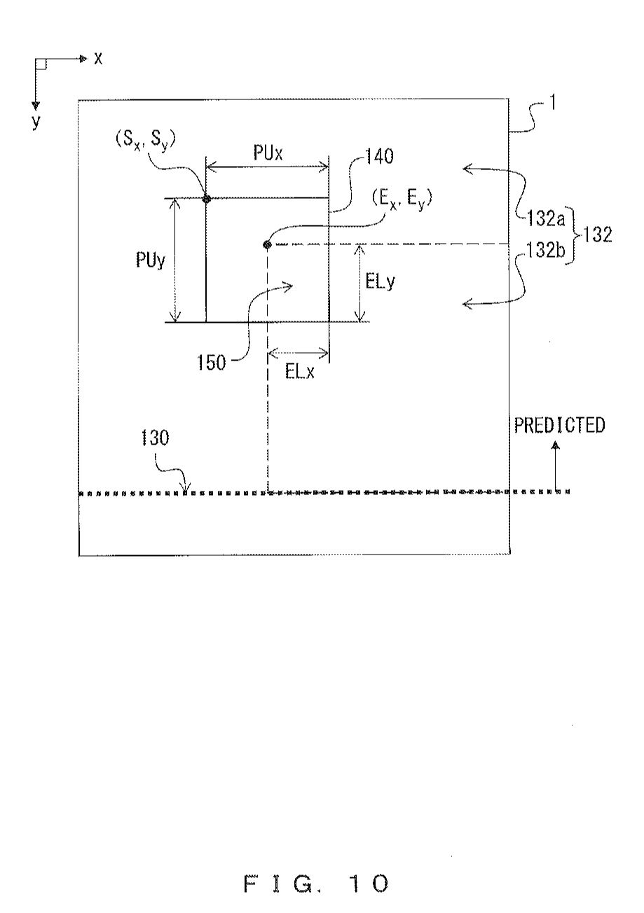

FIG. 10 explains a specifying method of an area in which a locally-decoded image does not exist in a predicted-image block.

As described above, the IBC process unit 203 of the video encoding device 2 generates a predicted image by searching an encoded area in a picture that is currently receiving an encoding process. However, in an encoding process of a video, a pipeline delay is caused as described above, and as illustrated in for example FIG. 10, there sometimes exists an area in which a locally-decoded image has not been generated in a predicted-image block set on the basis of a search point.

In the example illustrated in FIG. 10, the size of a prediction block that is currently receiving an IBC process is PUx×PUy, and the predicted-image block 140 having the search point (Sₓ,S_{y}) as the origination is set in a picture. Also, the thick line crossing a lower portion of the picture 1 in FIG. 10 represents the boundary 130 between an area that has received a prediction process and an area that has not received a prediction process, and the portion higher than the boundary 130 is the predicted area 132 that has received a prediction process. Further, the dashed line in the predicted area 132 represents the boundary between the area 132a in which a locally-decoded image exists and an area 132b in which a locally-decoded image does not exist.

In other words, in the example illustrated in FIG. 10, the lower right rectangular area 150 in the set predicted-image block 140 is included in an area in which a locally-decoded image does not exist. Therefore, it is not possible for the IBC predicted image generation unit 203c to generate a predicted image having the entire area of the predicted-image block 140 as a locally-decoded image.

However, in a process performed by the IBC process unit 203, the area 132a in which a locally-decoded image exists and the area 132b in which it does not exist in the predicted-image block 140 are first calculated in the locally-decoded image area calculation unit 203b as described above. The locally-decoded image area calculation unit 203b refers to a locally-decoded image stored in the locally-decoded image storage unit 260, and calculates the area 132b in which a locally-decoded image has not been generated in the predicted area 132 that have terminated the prediction process. The encoding of the picture 1 is performed in the raster scan order in units of coding tree units, and encoding and decoding processes in coding tree units are performed in units of coding units. This makes it possible for the area 132b to be represented by a rectangular area or a polygonal area that can be divided into a plurality of rectangular areas. Accordingly, the locally-decoded image area calculation unit 203b calculates the area 132b in which a locally-decoded image does not exists as one rectangular area and treats the coordinates (Eₓ,E_{y}) at the upper left corner of the rectangular area as information representing the position of the area 132b. Thereby, when Fₓ≧Eₓ and F_{y}≧E_{y} for a point (Fₓ, F_{y}), the point (Fₓ, F_{y}) can be determined to be included in the area 132b.

The locally-decoded image area calculation unit 203b calculates the coordinates (Eₓ,E_{y}), which represents the area 132b in the predicted area 132, as information representing an area in which a locally-decoded image exists. Then, the locally-decoded image area calculation unit 203b reports, to the IBC predicted image generation unit 203c, the coordinates (Eₓ,E_{y}), which represents the position of a rectangular area in which a locally-decoded image does not exist.

Accordingly, the IBC predicted image generation unit 203c determines that there is an area in which a locally-decoded image does not exist in the predicted-image block 140 when an external area of predicted-image block [Sₓ, S_{y}]˜(Sₓ+PUx, Sₓ+PUy) originating at search point (Sₓ,S_{y}) includes the coordinates (Eₓ,E_{y}).

The position of the area 132b in which a locally-decoded image does not exist in a case when the coordinates (Eₓ,E_{y}) is included in a predicted-image block can be specified by the coordinates (Eₓ,E_{y}). Also, the dimensions ELx×ELy of the area 132b in which a locally-decoded image does not exist can be calculated from equations (1-1) and (1-2) below by using the dimensions of the predicted-image block 140 and the coordinates (Eₓ,E_{y}), which represents the position of the area 132b in which a locally-decoded image does not exist.

ELₓ(Sₓ+PUx)−Eₓ (1-1)

EL_{y}=(S_{y}+PUy)−E_{y} (1-2)

When the position (Eₓ, E_{y}) and dimensions ELx×ELy of the area 150 in which a locally-decoded image does not exist in the predicted-image block 140 are obtained, area information including position (Eₓ,E_{y}) and dimensions ELx×ELy is transmitted to the IBC predicted image generation unit 203c. Receiving position (Eₓ,E_{y}) and dimensions ELx×ELy, the IBC predicted image generation unit 203c reads partial original image data corresponding to the area 150 in which a locally-decoded image does not exist in the predicted-image block 140 from the original image storage unit 203d (step S602).

Meanwhile, the IBC predicted image generation unit 203c uses the position (Sₓ,S_{y}) and dimensions PUx×PUy of the predicted-image block so as to read the locally-decoded image in the predicted-image block 140 from the locally-decoded image storage unit 260. For this, even when the entirety of the predicted-image block 140 is specified as an area from which a locally-decoded image is to be read, only a locally-decoded image existing in the predicted-image block is read. When the area 150 in which a locally-decoded image does not exist exists in a predicted-image block in a case when the entirety of the predicted-image block 140 is specified as a reading scope of a locally-decoded image, a predicted image lacking a rectangular area corresponding to the area 150 in which a locally-decoded image does not exist is obtained. However, by synthesizing (fitting) partial data of the above original image with this lacking area 150, it is possible to treat it as a predicted image for the entire predicted-image block 140.

Note that the specifying method of the area 150 in which a locally-decoded image does not exist in the predicted-image block 140 explained in FIG. 10 is an example and an area in which a locally-decoded image does not exist may be specified by other methods.

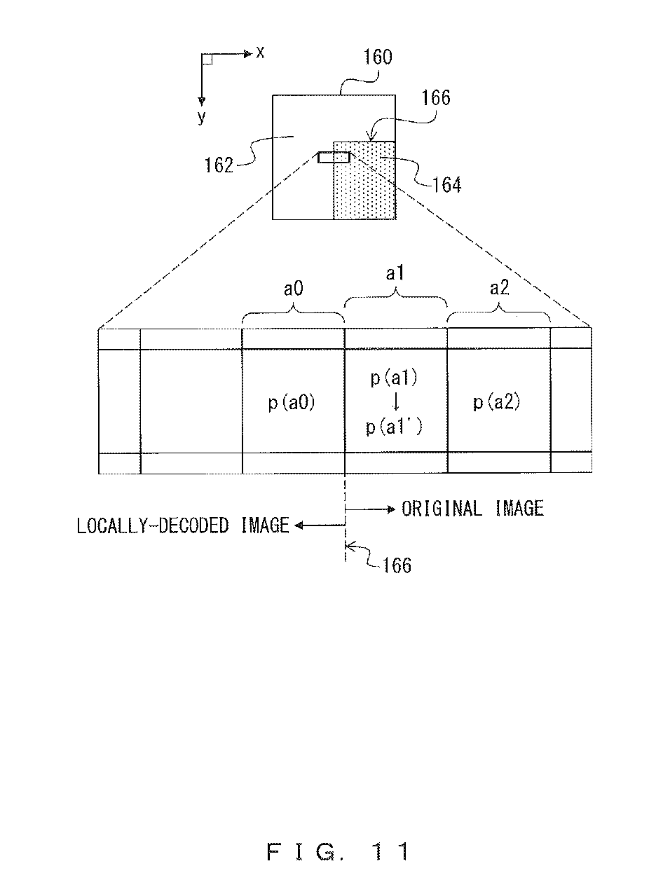

FIG. 11 explains an example of a filter process.

The IBC predicted image generation unit 203c, when the predicted-image block 140 includes an area in which a locally-decoded image does not exist 150, generates a predicted image by using a locally-decoded image and an original image. On a locally-decoded image, a quantization error component that is not zero is usually superimposed. For this, an original image can be considered to have zero as a quantization error component. Accordingly, when a predicted image has been generated by fitting an original image into area in which a locally-decoded image does not exist, discontinuity is caused in pixels for the amount of the quantization error at the boundary between the locally-decoded image and the original image in the predicted-image block 140. This discontinuity of pixel values may cause an edge at the boundary between a locally-decoded image and an original image in a predicted image, giving noise to an encoding cost. Thus, in the video encoding device 2 of the present embodiment, in order to suppress noise of an encoding cost caused by pixel-value discontinuity, a filter process is performed for pixel of an original image neighboring a locally-decoded image in a predicted image so as to perform smoothing.

When there is a possibility that an edge will be caused at the boundary between a locally-decoded image area and an original image area in a generated predicted image, giving noise to an encoding cost, the IBC process unit 203 makes the filter process unit 203e perform a filter process. Whether or not to make the filter process unit 203e perform a filter process is determined on the basis of for example a degree of discontinuity in pixel values at the boundary between a locally-decoded image area and an original image area. When a quantization error of a locally-decoded image is zero or a small value close to zero around the boundary between a locally-decoded image area and an original image area, the degree of the discontinuity in pixel values at the boundary is low and the possibility of occurrence of an edge at the boundary is low. When a quantization error is a large value around the boundary between a locally-decoded image area and an original image area, the degree of discontinuity is high and the possibility of occurrence of an edge that gives noise to an encoding cost is high. Accordingly, the IBC predicted image generation unit 203c makes the filter process unit 203e perform a filter process when a quantization error of a locally-decoded image around the boundary for example between a locally-decoded image area and an original image area is greater than a prescribed threshold.

When a filter process is performed by the filter process unit 203e, a predicted image 160 includes a locally-decoded image area 162 and an original image area 164 as illustrated in FIG. 11. The IBC predicted image generation unit 203c reports to the filter process unit 203e information representing a boundary 166 between the locally-decoded image area 162 and the original image area 164. Receiving the report, the filter process unit 203e treats pixel a1 along the boundary 166 in the original image area 164 as a target of a filter process as illustrated in FIG. 11 for example. When a filter process is performed on pixel a1 neighboring the locally-decoded image having the vertical boundary 166 between them, the IBC process unit 203 reads three pixel values p(a0), p(a1) and p(a2) of pixel a0 of the locally-decoded image and pixels a1 and a2 of an original image arranged in the horizontal directions. Then, using read three pixel values p(a0), p(a1) and p(a2), the pixel value of pixel a1 of an original image is replaced from p(a1) with p(a1′) by a three-tap (1,2,1) filter process represented by equation (2) below.

p(a1′)={p(a0)+2·p(a1)+p(a2)}/4 (2)

Also, when a horizontal part also exists in the boundary 166 as illustrated in FIG. 11, a similar filter process is performed by using the pixel of one locally-decoded image and the pixels of two original images that are arranged vertically, on an optical pixel neighboring a locally-decoded image having the horizontal boundary 166 between them.

Note that the filter process explained in FIG. 11 is an example, and the filter coefficient and the number of filter taps can be changed on an as-needed basis. Also, a pixel having its pixel value replaced in a filter process may be a pixel of a locally-decoded image neighboring an original image having the boundary between them or may be pixels of both an optical pixel and a locally-decoded image neighboring having the boundary between them. Further, a pixel having its pixel value replaced in a filter process may be a plurality of original image pixels arranged in horizontal or vertical directions, pixels of a plurality of locally-decoded images, or both of them.

In the IBC process unit 203, after performing generation process (step S4) of a predicted image using only a locally-decoded image or a generation process (step S6) of a predicted image using a locally-decoded image and an original image, an encoding cost is calculated in the cost calculation unit 203f (step S5 or step S7).

In the cost calculation unit 203f of the IBC process unit 203, a predicted image generated in the IBC predicted image generation unit 203c and the original image of a prediction unit that is currently receiving a prediction process are used so as to calculate an encoding cost. Also, while a cost is calculated for one prediction unit by changing a search point, the cost calculation unit 203f holds minimum cost Cmin that leads to a minimum value as an encoding cost calculated in the search scope and the coordinates (Sₓ_{_}ₘᵢₙ,S_{y}_{_}ₘᵢₙ) of the search point that results in a minimum cost value. When the calculation of a cost for one prediction unit is terminated, the cost calculation unit 203f outputs, to the mode selection unit 204, an encoding parameter including the coordinates (Sₓ_{_}ₘᵢₙ, S_{y}_{_}ₘᵢₙ) for the predicted image resulting in minimum cost Cmin.

When a predicted image used for calculating an encoding cost is a predicted image generated by using a locally-decoded image and an original image, the cost calculation unit 203f makes the correction amount calculation unit 203g calculate a correction amount so as to calculate an encoding cost by using the correction amount (step S8).

As a method of determining a parameter for encoding including Intra Block Copy, a method referred to as RateDistortion (RD) optimization is often used, which calculates an encoding cost corresponding to each parameter value so as to select a parameter value that results in a minimum cost. Encoding cost C is generally defined by equation (3) below.

C=D+λ·bit (3)

In equation (3), λ represents a parameter of the method of Lagrange multiplier, and is calculated in a form that is proportional to a quantization parameter for suppressing a compression rate. Also, for parameter D in equation (3), a prediction error or an encoding error is used. Also, bit in equation (3) represents the number of necessary bits or an approximate value of the number of bits for performing entropy coding on a parameter value that is evaluated as encoding cost C.

By minimizing encoding cost C on the basis of the method of Lagrange multiplier, a parameter value that optimally achieves the trade-off between parameter D and value bit in equation (3) can be selected. For parameter D, a prediction error or an encoding error is used. Further, when an estimation standard for an error is a prediction error, an absolute value sum conversion difference that uses a sum of absolute difference, a difference square sum and Hadamard transform between an original image and a predicted image is used for parameter D. When an encoding error is used for the estimation standard of an error, an absolute value sum conversion difference or a difference square sum between an original image and a locally-decoded image is often used.

Using a prediction error for the estimation standard of an error results in a situation where even when a parameter of encoding is optimized in the standard of a prediction error, it is not always optimized in the standard of the encoding error. Accordingly, when a prediction error is used for the estimation standard of an error, the compression rate decreases while the calculation amount is reduced because a locally-decoded image is not generated. When a locally-decoded image is used, a generation process of a locally-decoded image is performed on the basis of a parameter not selected as a result of calculation of encoding cost C.

The cost calculation unit 203f calculates an absolute value sum conversion difference that has accumulated for the amount of pixels in a block between the original pixel and a predicted image as parameter D of encoding cost C represented by equation (3). Sum D of absolute difference is calculated by using for example equation (4) below.

$$D = {\sum }_{i , j} \vert Org ( p x + i , p y + j ) - Pred ( i , j ) \vert \\ ( 0 < i , j < PU size ) \qquad ( 4 )$$

px and py in equation (4) are respectively the values of the x and y coordinates of the coordinates (px, py) of a pixel in the upper left corner of the prediction unit that is currently receiving a prediction process. Org(px+i, py+j) in equation (4) is a pixel value of an original image pixel at coordinates (px+i, py+j). Also, Pred(i, j) in equation (4) is a pixel value of a pixel at coordinates (i, j) in a predicted image. Pixel value Pred(i, j) of a predicted image is calculated by equation (5) below.

$$Pred ( i , j ) = \{ \begin{matrix}Ldec ( sx + i , sy + j ) & ( ( sx + i , sy + j ) ∈ P 0 ) \\ Org ( sx + i , sy + j ) & ( ( sx + i , sy + j ) ∈ P 1 )\end{matrix} \qquad ( 5 )$$

In equation (5), P0 is the locally-decoded image area 162 in the predicted image 160, and P1 is the original image area 164 in the predicted image 160. Ldec(sx+i,sy+j) and Org(sx+i,sy+j) in equation (5) are respectively the pixel values in a case when the coordinates (sx+i,sy+j) are a pixel in a locally-decoded image and in a case when the coordinates (sx+i,sy+j) are a pixel in an original image.

Note that Sum D of absolute difference is not limited to equation (4) and may be calculated by using for example equation (6) below.

$$D = {\sum }_{i , j} {\{ Org ( p x + i , p y + j ) - Pred ( i , j ) \}}^{2} \qquad ( 6 )$$

Also, the cost calculation unit 203f calculates estimated value B for the number of bits used for the encoding that uses the coordinates of the search point as reference coordinates of Intra Block Copy. The cost calculation unit 203f calculates estimated value B by using equation (7) by assuming for example that difference vectors (sx−px,sy−py), which are relative coordinates from the prediction unit as reference coordinates, are encoded by Golomb coding.

B=2·log(2|sx−px|+1)+2·log(2|sy−py|+1)+2 (7)

After calculating sum D of absolute difference and estimated value B of the number of bits, the cost calculation unit 203f calculates encoding cost C by using equation (8) below.

C=D+λ·B (8)

Also, when encoding cost C of equation (8) has been calculated for a predicted image generated by using a locally-decoded image and an original image, the cost calculation unit 203f corrects calculated encoding cost C.

Because an original image pixel does not include noise such as an quantization error etc., which is included in a locally-decoded image, generation of a predicted image including an original image tends to result in a small prediction error. Accordingly, it is sometimes not possible to perform fair comparison between a cost for a case when a predicted image includes an original image and a cost for a case when a predicted image is generated only from a locally-decoded image. Accordingly, the present embodiment estimates a difference between an original image included in a predicted image and a locally-decoded image generated when that original image receives an encoding process so as to perform correction of adding it to encoding cost C. This makes it possible to make an encoding cost calculated by using a predicted image including an original image closer to a virtual encoding cost calculated by using all locally-decoded image for a predicted image.

When an original image is included in a predicted image, the cost calculation unit 203f makes the correction amount calculation unit 203g calculate an estimated value of a difference between an original image included in a predicted image and a locally-decoded image generated when that original image receives an encoding process. The correction amount calculation unit 203g calculates quantization error QDistOffset(qp) per one pixel by using for example equation (9) below.

$$QDistOffset ( qp ) = \frac{{2}^{( qp - 12 ) / 3}}{12} \qquad ( 9 )$$

qp in equation (9) is a quantization parameter.

The correction amount calculation unit 203g reads, from the QP information storage unit 203h, a quantization parameter used for quantization of a transform block corresponding to an area in which a locally-decoded image does not exist on the basis of area information calculated by the e 203b. In the QP information storage unit 203h, a quantization parameter used for each block obtained from the transform/quantization unit 220 is stored. The correction amount calculation unit 203g outputs, to the cost calculation unit 203f, quantization error QDistOffset(qp) calculated by substituting value qp of a quantization parameter read from the QP information storage unit 203h into equation (9). Receiving quantization error QDistOffset(qp), the cost calculation unit 203f calculates encoding cost C by using equation (10) below.

C=D+λ·B+No·QDistOffset(qp) (10)

No in equation (10) is the number of pixels of an original image included in a predicted image.

Note that quantization error QDistOffset(qp) per one pixel is not limited to equation (9) and may be an arbitrary function that is in proportion to quantization parameter qp.

Also, for the correction amount calculation unit 203g, it is possible to calculate a picture average value by using quantization parameter qp read from the QP information storage unit 203h for example so as to treat the average value as the qp value of the next picture.

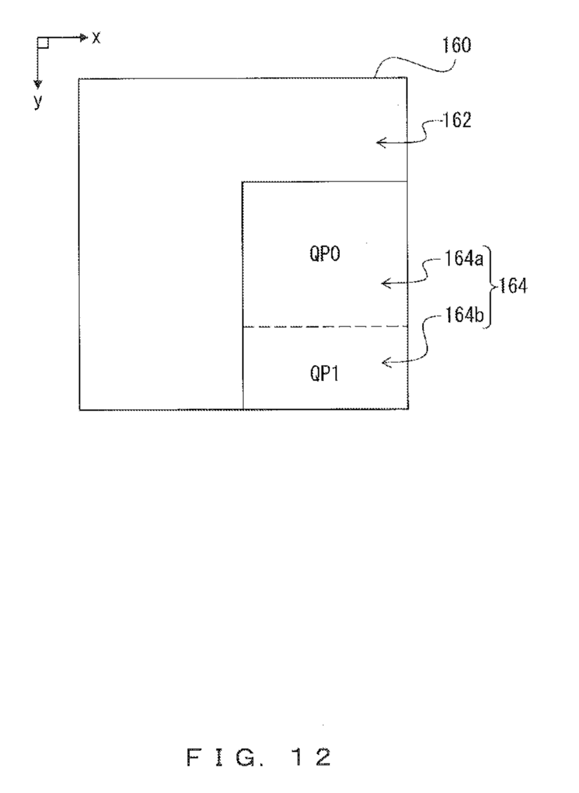

FIG. 12 explains another example of a correction method of an encoding cost.

Orthogonal transform and a quantization process for one coding unit (CU) can be performed in a form that they are divided into rectangular units that are referred to as transform units (TUs). Also, the divisional form of a transform unit can be set separately from the divisional form of a prediction unit. Further, a search point as the origination of a predicted-image block can be set at an arbitrary position in a search scope. Accordingly, when the predicted image 160 for a prediction unit that is currently receiving a prediction process is generated, a plurality of areas having different quantization parameters are sometimes included in the original image area 164 as illustrated in FIG. 12 for example. In the example illustrated in FIG. 12, the original image area 164 of the predicted image 160 includes an area 164a where quantization parameter qp=QP0 and an area 164b where quantization parameter qp=QP1.

As described above, when a plurality of areas having quantization parameters are included in the original image area 164, the correction amount calculation unit 203g calculates first quantization error QDistOffset(QP0) and second quantization error QDistOffset(QP1) by using equation (9).

Also, the cost calculation unit 203f uses number No 1 of the pixels of the area 164a of quantization parameter QP0, number No2 of the pixels of the area 164b of quantization parameter QP1 and two quantization errors received from the correction amount calculation unit 203g so as to calculate encoding cost C by equation (11) below.

C=D+λ·B+No1·QDistOffset(QP0)+No2·QDistOffset(QP1) (11)

In other words, when a plurality of areas having different quantization parameters are included in the original image area 164 of the predicted image 160, the correction amount calculation unit 203g calculates k quantization errors QDistOffset(qpₖ) in accordance with number k of the types of the quantization parameters. Then, the cost calculation unit 203f uses number NOₖ of the pixels included in an area of each quantization parameter and k quantization errors QDistOffset(qpₖ) calculated by the correction amount calculation unit 203g so as to calculate encoding cost C by equation (12) below.

$$C = D + λ \cdot B + {\sum }_{k} \{ {No}_{k} \cdot QDistOffset ( {qp}_{k} ) \} \qquad ( 12 )$$

After calculating and evaluating encoding costs C for all search points, the cost calculation unit 203f outputs search point (Sₓ_{_}ₘᵢₙ,S_{y}_{_}ₘᵢₙ) resulting in a minimum cost as reference coordinates of Intra Block Copy that achieves the best compression ratio in the prediction unit.

As described above, according to the present embodiment, when there is an area in which a locally-decoded image does not exist in a predicted-image block in Intra Block Copy (IBC process), a predicted image that uses an original image for that area is generated. Accordingly, even when a delay is caused in a process after for example a prediction process and there is an area in which a locally-decoded image has not been generated in a search scope at a timing of performing an IBC process, a predicted image can be generated. Thus, in a process performed by the IBC process unit 203 of the present embodiment, it is possible to treat also an area in which a locally-decoded image has not been generated as a prediction target from among areas for which a prediction process is terminated. In other words, according to the present embodiment, restrictions of a search scope of a predicted image caused by non-existence of a locally-decoded image when prediction is performed by Intra Block Copy is suppressed (relaxed), increasing a possibility that the most appropriate predicted image will be generated. Accordingly, the present embodiment makes it possible to suppress reduction in the encoding efficiency caused by a delay in generation of a locally-decoded image in video encoding that uses Intra Block Copy.

Also, in Intra Block Copy according to the present embodiment, when a predicted image is generated by using a locally-decoded image and an original image, an encoding cost calculated on the basis of a predicted image and an original image is corrected. Further, an estimation value of a quantization error (distortion amount) in a case when an original image area in a predicted image is quantized is calculated and an encoding cost is corrected by using the estimated value of the quantization error and the number of pixels in the original image area. Accordingly, it is possible to make an encoding cost closer to a virtual encoding cost calculated on the basis of a predicted image generated by using only a locally-decoded image, the encoding cost being calculated on the basis of a predicted image generated by using a locally-decoded image and an original image. Accordingly, it is possible to perform fair comparison between an encoding cost calculated on the basis of a predicted image including an original image area and an encoding cost calculated on the basis of a predicted image using only a locally-decoded image, increasing a possibility that the most appropriate prediction result (encoding parameter) will be calculated.

Also, in Intra Block Copy of the present embodiment, when a predicted image is generated by using a locally-decoded image and an original image, a filter process is performed on a pixel in the boundary portion between a locally-decoded image and an original image. This makes it possible to smooth discontinuity of pixel values at the boundary between a locally-decoded image including a quantization error that is not zero and an original image in which a quantization error is zero. This makes it possible to suppress occurrence of an edge at the boundary between a locally-decoded image and an original image, reducing noise given to an encoding cost.

Note that the H.265/HEVC standard exemplified in the above embodiment is just an example of a video encoding standard to which Intra Block Copy can be applied, and Intra Block Copy of the present embodiment can be applied to a different coding standard.

Also, the flowcharts of FIG. 8 and FIG. 9 are just exemplary, and some of the processes can be omitted or changed in accordance with the configuration or condition of the IBC process unit 203 of the video encoding device 2. Also, the specifying method of an area in which a locally-decoded image does not exist in FIG. 10 is just an example and information for specifying an area can be changed in accordance with the configuration or condition of the IBC process unit 203. Note that the filter process explained in FIG. 11 is an example, and the filter coefficient and the number of filter taps can be changed in accordance with the configuration or condition of the IBC process unit 203. Also, in the IBC process according to the present embodiment, not only the filter process using the above three-tap filter but also for example a low-pass filter can be performed on an original image used for a predicted image.

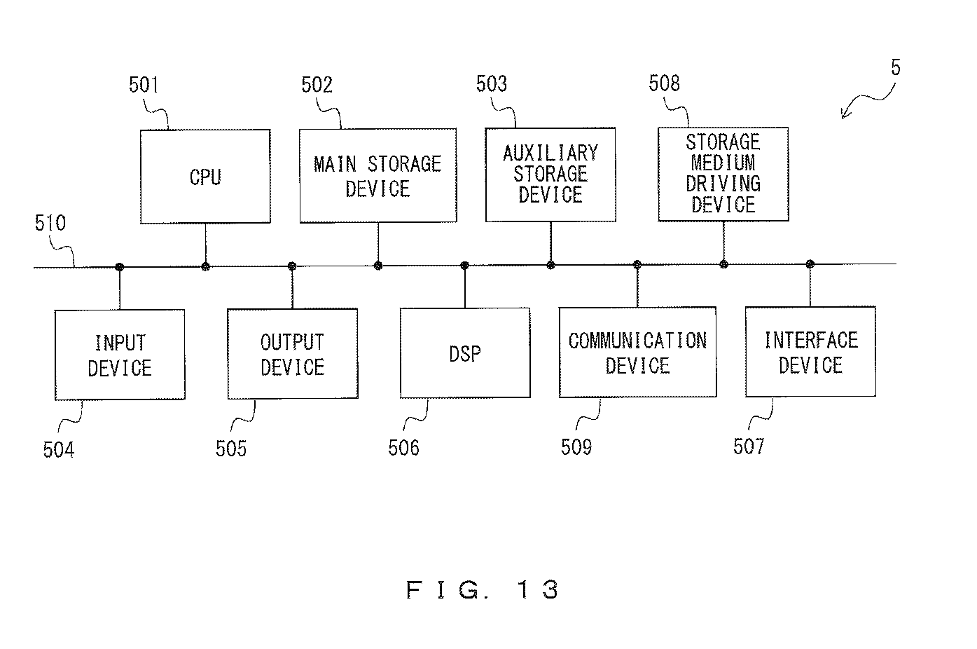

Also, the above video encoding device 2 can be implemented by for example a computer and a program that makes the computer execute an encoding process including the above IBC process. Hereinafter, explanations will be given for the video encoding device 2 that is implemented by a computer and a program, by referring to FIG. 13.

FIG. 13 illustrates a hardware configuration of a computer. As illustrated in FIG. 13, a computer 5 that operates as the video encoding device 2 includes a central processing unit (CPU) 501, a main storage device 502, an auxiliary storage device 503, an input device 504 and an output device 505. Also, the computer 5 further includes a digital signal processor (DSP) 506, an interface device 507, a storage medium driving device 508 and a communication device 509. These components 501 through 509 in the computer 5 are connected to each other via a bus 510 so that data can be exchanged between the components.

The CPU 501 is an arithmetic process device that controls the overall operations of the computer 5 by executing various types of programs including the operating system.

The main storage device 502 includes a read only memory (ROM) and a random access memory (RAM). The ROM has recorded in advance for example a prescribed basic control program read by the CPU 501 upon the activation of the computer 5. Also, the RAM is used as a working storage area as needed when the CPU 501 executes various types of programs. The RAM can be used for temporarily storing for example a picture that is currently receiving an encoding process (original image data), a locally-decoded image and data, etc. calculated in a prediction process by the prediction process unit 200.

The auxiliary storage device 503 is a storage device, such as a hard disk drive (HDD) etc., having a capacity larger than that of the main storage device 502. The auxiliary storage device 503 can store various types programs executed by the CPU 501, and various types of data etc. Examples of programs stored in the auxiliary storage device 503 include, among others, an application program that performs encoding and reproduction of video data and a program that creates (generates) video data. Examples of data stored in the auxiliary storage device 503 include, among others, video data as a coding target and encoded video data.

The input device 504 is for example a keyboard device and a mouse device, and in response to a manipulation by the operator of the computer 5, transmits input information associated with the manipulation to the CPU 501.

The display device 505 is for example a display device such as a liquid crystal display device etc. The liquid crystal display displays various types of texts, images, etc. in accordance with display data transmitted from the CPU 501. Note that the output device 505 includes for example a printer, a speaker, etc.

The DSP 506 is an arithmetic process device that performs some of processes etc. in an encoding process of a video data in accordance with a control signal etc. from the CPU 501.

The interface device 507 is an input/output device that connects the computer 5 and other electronic devices so as to permit transmission and reception of data between the computer 5 and other electronic devices. The interface device 507 is provided with for example a terminal that can connect a cable having a connector based on a universal serial bus (USB) standard, a terminal that can connect a cable having a connector based on a High-Definition Multimedia Interface (HDMI) standard, etc. Examples of electronic devices that can be connected to the computer 5 by the interface device 507 include an image pickup device such as a digital video camera etc.

The storage medium driving device 508 reads a program or data recorded in a portable storage medium (not illustrated) and writes data etc. stored in the auxiliary storage device 503 to the portable storage medium. As a portable storage medium, a flash memory provided with for example a connector based on a USB standard can be used. Also, as a portable storage medium, an optical disk such as a compact disk (CD), a digital versatile disc (DVD), Blu-ray Disc (Blu-ray is a registered trademark), etc. can also be used.

The communication device 509 is a device that connects the computer 5 and a communication network such as the Internet, a local area network (LAN), etc. so that communications are possible between them and controls communications with other communication terminals via a communication network. The computer 5 can transmit encoded video data (bit stream) to other communication terminals via the communication device 509 and a communication network.

The computer 5 makes the CPU 501 read a program including the above encoding process from a non-transitory recording medium (such as the auxiliary storage device 503 etc.) and perform an encoding process and a decoding process of video data in cooperation with the DSP 506, the main storage device 502, the auxiliary storage device 503, etc. Upon this, the CPU 501 makes the DSP 506 perform arithmetic processes such as a prediction process including an IBC process, orthogonal transform after a prediction process, quantization, entropy coding and decoding processes, etc.

Video data (encoded bit stream) encoded by the computer 5 can be transmitted to for example a different computer etc. via a communication network as described above. Also, video data encoded by the computer 5 can also be stored in the auxiliary storage device 503 so that it is decoded (reproduced) by the computer 5 on an as-needed basis. Further, video data encoded by the computer 5 can also be distributed in a form that it is stored in a recording medium by using the storage medium driving device 508.

Note that the computer 5 used as the video encoding device 2 does not have to include all the constituents illustrated in FIG. 13, and some of the constituents may be omitted in accordance with purposes and conditions. For example, it is possible to perform the above encoding and decoding processes in the CPU 501 by omitting the DSP 506 when the CPU 501 has a high processing ability. Also, when the DSP 506 is made to perform an encoding process of video data etc., an external memory that stores video data to receive an encoding process may be provided separately from for example the above main storage device 502 and the auxiliary storage device 503.

Also, the computer 5 is not limited to a general-purpose type that implements a plurality of functions by executing various types of programs and may be an information processing apparatus that is dedicated to an encoding process of videos. Further, the computer 5 may be an information processing apparatus dedicated to an encoding process of videos and a decoding process of encoded videos.

Further, the computer 5 may be for example a server in VDI. In such a case, the computer 5 implements a plurality of virtual machines corresponding to a plurality of terminals connected via a network. The plurality of virtual machines create, at prescribed time intervals, window data displayed on a display device connected to a terminal. The computer 5 encodes window data created by these virtual machines, through an encoding process including the IBC process according to the present embodiment, and transmits it to each terminal so as to make the display device of each terminal display it.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A video encoding device comprising:
a memory; and
a processor that is connected to the memory, that divides a picture as a coding target into a plurality of blocks so as to set a prediction unit block or a plurality of prediction unit blocks for each of the blocks, that generates a predicted image for the prediction unit block by using a locally-decoded image in an area for which an encoding process is terminated in a picture of the coding target for each of the prediction unit blocks, and that further performs a process of calculating the predicted image resulting in a minimum encoding cost, wherein
the process of calculating the predicted image includes
calculating an area in which the locally-decoded image exists in an area for which the encoding process is terminated in a picture as the coding target and an area in which the locally-decoded image does not exist,
generating the predicted image by using the locally-decoded image in the predicted-image block and an original image data of an area in which the locally-decoded image does not exist when an area in which the locally-decoded image does not exist is included in a predicted-image block set in an area for which the encoding process is terminated in a picture as the coding target, and
calculating an encoding cost on the basis of the predicted image and the original image data of the prediction unit block so as to calculate the predicted image resulting in the minimum encoding cost while changing a position of coordinates specified in an area for which the encoding process is terminated.

2. The video encoding device according to claim 1, wherein
the processor
calculates a correction amount in accordance with dimensions of the original image data included in the predicted image for an encoding cost calculated on the basis of the predicted image generated by using the locally-decoded image and the original image data and the prediction unit block, and
treats, as an encoding cost for the predicted image, a value obtained by adding the correction amount to an encoding cost calculated on the basis of the predicted image generated by using the locally-decoded image and the original image data and the prediction unit block.

3. The video encoding device according to claim 2, wherein
the processor further
calculates a predicted image resulting in the minimum encoding cost by referring to an encoded picture,
calculates a predicted image resulting in the minimum encoding cost by referring to a pixel neighboring the prediction unit block in a picture as the coding target,
generates a prediction error signal from a predicted image for the block generated on the basis of the encoding cost in each of the calculated predicted images and the original image data,
performs orthogonal transform on the generated prediction error signal, and
quantizes a transform coefficient obtained in the orthogonal transform, wherein
the processor calculates the correction amount by using a quantization parameter for quantizing the transform coefficient.

4. The video encoding device according to claim 3, wherein
the processor further
uses the quantization parameter so as to calculate an estimated value of a quantization error for a case when the original image data included in the predicted image is quantized.

5. The video encoding device according to claim 2, wherein
when partial areas of the plurality of blocks in an area for which the encoding process is terminated are included in an area of the original image data in the predicted image, the processor divides the area of the original image data into a plurality of partial areas corresponding to partial areas of the blocks so as to calculate the correction amount for each of the partial areas of the original image data.

6. The video encoding device according to claim 1, wherein
the processor further
smoothes a pixel value by performing a filter process on a pixel in a boundary portion between an area of the locally-decoded image and an area of the original image data in the predicted image when the predicted image is generated by using the locally-decoded image and the original image data.

7. The video encoding device according to claim 1, wherein
the processor further
performs a low-pass filter on the original image data corresponding to an area in which the locally-decoded image does not exist when the predicted image is generated by using the locally-decoded image and the original image data.

8. A video encoding method comprising:
an encoding process of a video including using a computer to divide a picture as a coding target into a plurality of blocks so as to set a prediction unit block or a plurality of prediction unit blocks for each of the blocks, to generate a predicted image for the prediction unit block from inside of an area for which an encoding process is terminated in a picture of the coding target for each of the prediction unit blocks, and further to perform a process of calculating the predicted image resulting in a minimum encoding cost, wherein
the process of generating the predicted image includes
calculating, by using the computer, an area in which the locally-decoded image exists in an area for which the encoding process is terminated in a picture as the coding target and an area in which the locally-decoded image does not exist,
generating, by using the computer, the predicted image by using the locally-decoded image in the predicted-image block and an original image data of an area in which the locally-decoded image does not exist when an area in which the locally-decoded image does not exist is included in a predicted-image block set in an area for which the encoding process is terminated in a picture as the coding target, and
calculating, by the computer, an encoding cost on the basis of the predicted image and the original image data of the prediction unit block so as to calculate the predicted image resulting in the minimum encoding cost while changing a position of coordinates specified in an area for which the encoding process is terminated.

9. The video encoding method according to claim 8, wherein
a correction amount is calculated, by using a computer, in accordance with dimensions of the original image data included in the predicted image for calculating an encoding cost on the basis of the predicted image generated by using the locally-decoded image and the original image data and the prediction unit block, and
an encoding cost for the predicted image is calculated by using the computer by adding the correction amount to the encoding cost calculated on the basis of the predicted image generated by using the locally-decoded image and the original image data and the prediction unit block.

10. The video encoding method according to claim 9, further comprising
calculating, by using the computer, a predicted image resulting in the minimum encoding cost by referring to an encoded picture,
calculating, by using the computer, a predicted image resulting in the minimum encoding cost by referring to a pixel neighboring the prediction unit block in a picture as the coding target,
generating, by using the computer, a prediction error signal from a predicted image for the block generated on the basis of the encoding cost for each of the calculated predicted images and the original image data,
performing, by using the computer, orthogonal transform on the generated prediction error signal, and
quantizing, by using the computer, a transform coefficient obtained in the orthogonal transform, wherein
the computer calculates the correction amount by using a quantization parameter for quantizing the transform coefficient.

11. The video encoding method according to claim 10, further comprising
using the quantization parameter so as to calculate an estimated value of a quantization error for a case when the original image data included in the predicted image is quantized, by using a computer.

12. The video encoding method according to claim 9, wherein
when partial areas of the plurality of blocks in an area for which the encoding process is terminated are included in an area of the original image data in the predicted image, the area of the original image data is divided into a plurality of partial areas corresponding to partial areas of the blocks so as to calculate the correction amount for each of the partial areas of the original image data, by using the computer.

13. The video encoding method according to claim 8, further comprising
smoothing, by using the computer, a pixel value for a pixel in a boundary portion between an area of the locally-decoded image and an area of the original image data in the predicted image when the predicted image is generated by using the locally-decoded image and the original image data.

14. The video encoding method according to claim 8, further comprising
performing, by using the computer, a low-pass filter on the original image data corresponding to an area in which the locally-decoded image does not exist when the predicted image is generated by using the locally-decoded image and the original image data.

15. A non-transitory computer-readable recording medium having stored therein a program that causes a computer to execute an encoding process of a video and a process of generating a locally-decoded image of an encoded video, the encoding process of the video comprising:
dividing a picture as a coding target in the video into a plurality of blocks so as to set a prediction unit block or a plurality of prediction unit blocks for each of the blocks,
generating a predicted image for the prediction unit block from inside of an area for which an encoding process is terminated in a picture of the coding target for each of the prediction unit blocks, and
calculating the predicted image resulting in a minimum encoding cost, wherein
the process of generating the predicted image includes
calculating an area in which the locally-decoded image exists in an area for which the encoding process is terminated in a picture as the coding target and an area in which the locally-decoded image does not exist,
generating the predicted image by using the locally-decoded image in the predicted-image block and an original image data of an area in which the locally-decoded image does not exist when an area in which the locally-decoded image does not exist is included in a predicted-image block set in an area for which the encoding process is terminated in a picture as the coding target, and
calculating an encoding cost on the basis of the predicted image and the original image data of the prediction unit block so as to calculate a predicted image resulting in the minimum encoding cost while changing a position of coordinates specified in an area for which the encoding process is terminated.
